(19) United States
(12) Patent Application Publication
(10) Pub. No.: US 2011/0313795 A1
(43) Pub. Date: Dec. 22, 2011

(54) SYSTEM AND METHOD FOR ELECTRONIC POLICYHOLDER REVIEW USING DYNAMIC INTERVIEWS

(76) Inventors: Kenneth A. Phillips, Canton, GA (US); Michael T. Tetreault, Wethersfield, CT (US); Janis L. Ingham, Davenport, FL (US); James E. Arnold, Ellington, CT (US)

(21) Appl. No.: 13/117,612

(22) Filed: May 27, 2011

Related U.S. Application Data
(60) Provisional application No. 61/348,988, filed on May 27, 2010.

(51) Int. Cl. G06Q 40/00

(52) U.S. Cl. 705/4

(57) ABSTRACT

A policyholder report may be obtained by an insurer from an insured through a series of questions presented by an automated, electronic system. The insured may access the system through a portal, such as a graphical user interface, which may ask the insured a dynamic series of account and/or risk-based questions at or near the expiration of an insurance policy term, and permit the insured to submit verification and supporting information through the portal. Based on the insured's responses to the questions and the information provided, the insurer may complete a review and/or audit, and determine an adjustment to the premium. Additionally, the system may permit the insured and the insurer to review the audit during all stages of completion, and may allow the insured to opt out of the electronic process at any time, or to dispute the results of the audit through the portal.

### CROSS-REFERENCE TO RELATED APPLICATION

This application claims priority under 35 U.S.C. §119(e) to U.S. Patent Application No. 61/348,988, filed May 27, 2010, and entitled “System and Method for Electronic Policy Holder Review Using Dynamic Interviews,” which is incorporated by reference herein in its entirety.

### FIELD OF THE INVENTION

The invention relates generally to an electronic policyholder review. More specifically, the invention relates to conducting an electronic policyholder review using a dynamic interview.

### BACKGROUND

When an insurance policy, such as a workers' compensation, general liability, and/or automobile coverage policy, is written by an insurer on behalf of a business insurance customer (usually referred to as an “insured”), the insured is informed that the policy is subject to a premium audit at the end of the policy term. When the insurance policy expires or is cancelled, the term is considered closed and a premium audit adjustment becomes due.

Currently, premium audits may be conducted in two ways. The first is a physical audit, in which an auditor will meet with the insured and/or its designated representative to review verification records that will be used to calculate the actual exposure for the respective policy term. The second is a policyholder report (i.e., a mail audit or voluntary audit), which is a paper form containing questions and blank spaces for answers.

A policyholder report is a means of collecting necessary accounting and business-specific data for the purpose of performing an audit. Reviews of policyholder reports may be used in lieu of a physical audit by an insurer when specific criteria are met. Commonly, paper copies of relevant forms are mailed to the insured for completion after a policy expires. Insurers must follow the status of outstanding reports closely for many reasons, including to facilitate timely notification to states of non-compliance with audits.

The insured and/or its designated representative typically completes the policyholder report forms and returns the forms to the insurer via mail or fax, along with verification information. The insurer will review the submitted forms and accompanying documentation. If the insurer has any questions for the insured regarding the forms or the documentation, the insurer will contact the insured and/or its designated representative, such as by electronic mail, fax, and/or phone, to seek clarification.

Other methods of conducting an audit include use of a portal that allows an insured to identify and complete audit forms, which may sometimes be partially completed with the insured's demographic information and the classifications that appeared on its insurance policy. The portal may also include a sign off screen, and the customer may receive an acknowledgement of the submitted policyholder report. The customer also receives a reformatted version of their submitted forms for their records.

### BRIEF DESCRIPTION OF THE DRAWINGS

Various objects, features, and advantages of the present invention can be more fully appreciated with reference to the following detailed description, when considered in connection with the following drawings.

FIG. 1 is a block diagram of the components of an electronic policyholder review (“PHR”) system, in accordance with an embodiment of the present invention.

FIG. 2 is a block diagram of the components of an electronic PHR system, in accordance with another embodiment of the present invention.

FIG. 3 is a flow chart of an electronic PHR process according to one embodiment of the present invention.

FIG. 4 is a flow chart of an exemplary post-audit dispute path of an electronic PHR process according to one embodiment of the present invention.

FIG. 5 is a flow chart of an exemplary risk path interview of an electronic PHR process according to one embodiment of the present invention.

FIG. 6 is an analyst worksheet utilized in connection with an electronic PHR system according to one embodiment of the present invention.

### DETAILED DESCRIPTION

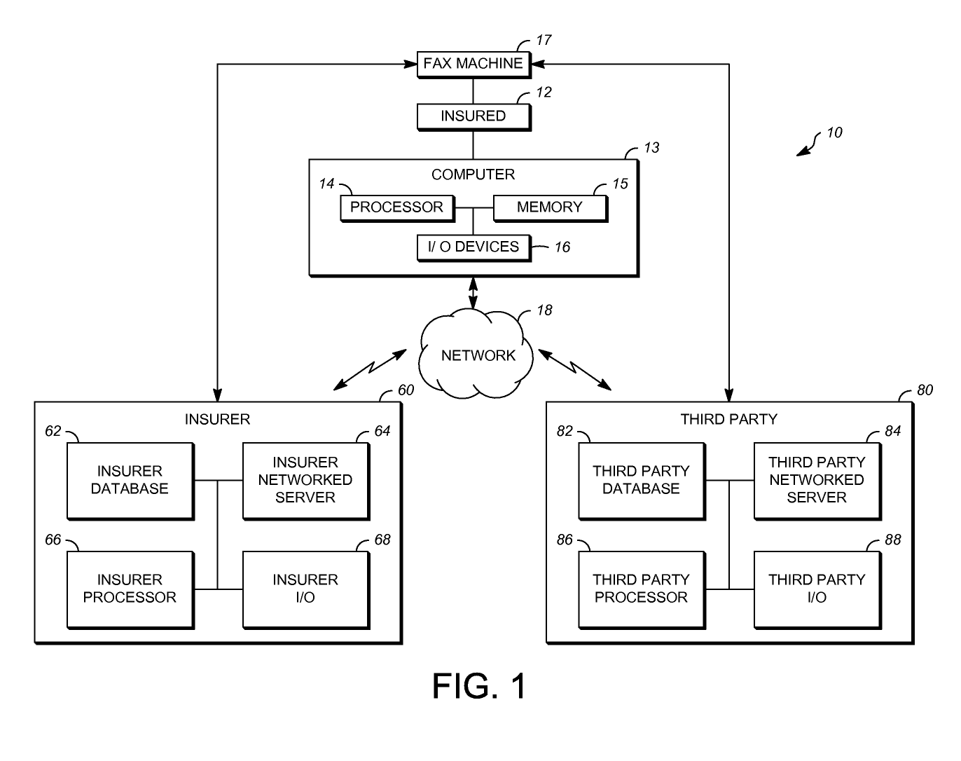

Referring to FIG. 1, a systems-level view of the various components of an electronic (e.g., web-based, network based, or other electronic or optical, wired or wireless, communication-based) policyholder review (“PHR”) and premium determination system according to one embodiment of the present invention is shown. The system 10 allows insureds (e.g., customers), and/or their designated representatives, to complete a dynamic (or interactive) premium audit, electronically. In particular, FIG. 1 shows a system 10 and various interconnections between an insured 12 (e.g., an insurance customer); an insurer 60 (e.g., an insurance company); and one or more third parties 80 over a network 18, which may be the Internet or another communications network. The insured 12 may have access to a computer 13 having at least one processor 14, memory 15, and one or more input/output (“I/O”) devices 16 that is connected to the network 18. The insured 12 may also have access to a fax machine 17, which may also be electronically connected directly to the insured computer 13. The insurer 60 may operate and/or access one or more databases 62, a networked server 64, at least one processor 66, and one or more input/output devices 68 that may be connected to the network 18. The third party 80 may also operate and/or access one or more databases 82, a networked server 84, at least one processor 86, and one or more input/output devices 88 that may be connected to the network 18. Other arrangements of hardware and software, including various additional networked client and server computers and applications operating thereon, may also be used by the insured 12, the insurer 60, and/or the third party 80.

Those of skill in the pertinent art will recognize that the one or more insureds 12, insurers 60, and third parties 80 may use a keyboard, keypad, mouse, stylist, touch screen, “smart” phone or other device (not shown) or method using a browser or other like application for interacting with an external network 18, such as the Internet. The computers, servers, and the like described herein have the necessary electronics, software, memory, storage, databases, firmware, logic/state machines, microprocessors, communication links, displays or other visual or audio user interfaces, printing devices, and any other input/output devices to perform the functions described herein and/or achieve the results described herein

Except where otherwise explicitly or implicitly indicated herein, the terms “customer,” “insured,” “insurance company,” “insurer” or “third party” also refer to the associated computer systems operated or controlled by an insured, an insurer, or a third party, respectively. Furthermore, those of skill in the art will also recognize that process steps described herein as being performed by a “customer,” “insured,” “insurance company,” “insurer” or “third party” may be automated steps performed by their respective computer systems, and may be implemented within software modules (or computer programs) executed by one or more general purpose computers.

The protocols and components for providing the respective communications between the insured 12, the insurer 60, the third party 80, and the network 18 are well known to those skilled in the art of computer communications. As such, they need not be described in more detail herein. Moreover, the data and/or computer executable instructions, programs, firmware, software and the like (also referred to herein as “computer executable components”) described herein may be stored on a computer-readable medium that is within or accessible by computers or servers and may have sequences of instructions which, when executed by a processor (such as a central processing unit, or CPU), may cause the processor to perform all or a portion of the functions and/or methods described herein. Such computer executable instructions, programs, software and the like may be loaded into the memories of computers or servers, using drive mechanisms associated with the computer readable medium, such as a floppy drive, CD-ROM drive, DVD-ROM drive, network interface, or the like, or via external connections.

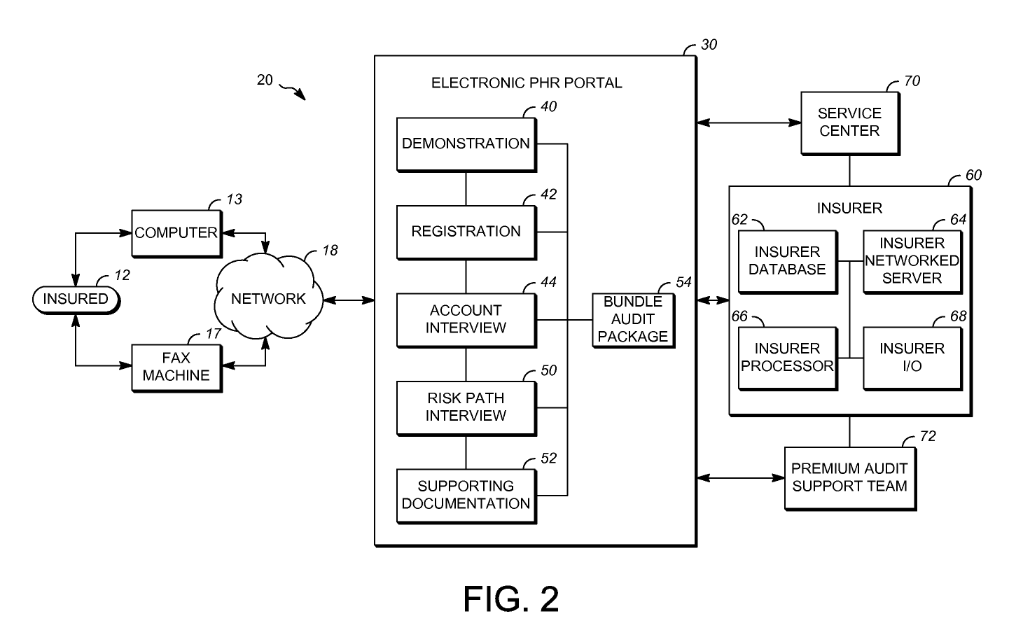

Referring to FIG. 2, an overview of an embodiment of an electronic PHR system 20 according to the present invention is shown. The system 20 displays the interactions between an insured 12, an electronic PHR system portal 30, and an insurer 60. As is shown in FIG. 2, the insured 12 may participate in an audit by utilizing the electronic PHR portal 30, which may be provided in the form of a web page displayed on a browser operating on the computer 13. The electronic PHR system portal 30 may be hosted on the insurance company networked server 64 or other insurance company computer or computer system. Alternatively, any of the features associated with the electronic PHR system portal 30 may be hosted by one or more third parties 80, as discussed below.

The insured 12 may access the portal 30 to complete a demonstration 40; to register 42 for an electronic PHR; to participate in an account interview 44 and/or a dynamic risk-path interview 50; and to submit additional documents 52 in connection with the audit. The electronic PHR portal 30 may also communicate with the insurer 60 over the network 18.

The insurer 60 may also utilize one or more databases 62 and/or networked servers 64, which may execute additional business logic to provide system intelligence for performing tasks, scheduling, and receiving or delivering information. In some embodiments of the present invention, the insurer 60 may also include a service center customer support team 70 and/or a premium audit support team 72, which may provide assistance to the insured 12 and/or facilitate the completion of an electronic PHR and the performance of the audit. The service center 70 and/or premium audit support team 72 may access the electronic PHR portal 30 directly over the network 18, and may also provide assistance to the insured 12 via a customer service portal (not shown).

The insured 12 may be any existing insurance customer who is participating in a premium audit at or near the end of an insurance policy term. The end result of the premium audit may be a premium audit adjustment, which more accurately reflects the risk taken by the insurer 60 on behalf of the insured 12 during the term of the policy. Some embodiments of the systems and methods of the present invention may also be used with many other types of audits and interviews. For example, in some cases, the premium audit may be supplemented by one or more interim audits, which may be carried out periodically (e.g., monthly) during the term of the policy. Embodiments of the present invention may also have applicability to interim audits.

Referring to the embodiment of the system 20 shown in FIG. 2, the insured 12 may use a computer to access the electronic PHR system portal 30 in order to complete an audit. The electronic PHR portal 30 may be accessed using any standard computer having a browser or other software, and may be built to include standard web technologies and web application platforms. For example, the electronic PHR portal 30 may include front-end applications that are implemented using HTML, Java, and JavaScript, and also back-end web applications that are implemented using Java servlets, J2EE, or any other standard language or protocol. Additionally, the insured 12 may also deliver documents or other information to the electronic PHR portal 30 using a fax machine 17 or other like communications device, either manually or via the computer 13.

The insured 12 may receive assistance while performing the audit process, for example, either in the form of automated assistance or from individuals at the service center 70, who may provide instructions as to how to use the portal 30, such as by telephone or online through the electronic PHR portal 30 or a customer service portal (not shown). The insured 12 may also receive assistance from the demonstration 40, which may provide audio, video, or documents that describe the audit process and/or the electronic PHR system 10 and its use.

The electronic PHR portal 30 may provide an interface for accessing additional business logic, which may be maintained by the insurer 60, and may enable an insured 12 to complete a PHR electronically. The insured 12 may be asked to participate in an audit, for example, after receiving a notification from the insurer 60, such as a letter, an E-mail, a facsimile, or other form of communication. The notification may provide the insured 12 with instructions for logging on to the electronic PHR portal 30 and for beginning the process of completing the premium audit by viewing the demonstration 40. After reviewing the demonstration 40, the insured 20 may register 42 with the portal 30. In some embodiments, registration allows the insured 12 to identify itself to the system 20, to record its progress, and to complete an interview at any time. The electronic PHR system 20 can also retrieve relevant information about the insured 12 and its policy from the database 62, which may contain customer and policy information.

After completing the registration 42 process, the insured 12 may conduct an account interview 44 and/or a dynamic risk path interview 50. Information that may be collected or reviewed during the account interview 44 may include, for example, the location of the business, the insured's mailing address, the insured's contact information at the business, the type of business, the insured's corporate structure (e.g., corporation, limited liability company, partnership, sole proprietorship), and the identity of any relevant contacts or delegates that may participate in the audit process. The account interview 44 may be dynamic, i.e., including questions that are targeted to the insured 12, the type of policy, and the type of business of the insured 12, or it may be standardized. In the account interview 44, subsequent questions may be based on the answers provided by the insured in response to previous questions, thereby creating a dynamic and customized interview for the insured 20.

After the account interview 44, the insured 12 may participate in a dynamic risk path interview 50, which asks questions that may be specific to the coverage provided under the policy, i.e., the business operated by the insured 12, in order to determine the various risk types that such coverage presents to the insurer 60. Therefore, the dynamic risk path interview 50 may include questions that are relevant to an insured's business, and the questions asked of the insured 12 may be based on answers provided by the insured 12 in response to other questions. For example, if the insured 12 indicates that it has contractors working at its business, questions may be asked regarding the number of contractors or the services that they provide. In addition, questions can also be customized based on an automatically identified risk path for the insured's business. As is described in further detail below, a risk path groups businesses with similar risk characteristics together, and such businesses are generally asked the same relevant questions in a dynamic risk path interview 50.

The risk path interview 50 generally includes one or more questions that relate specifically to the type of business being insured under the policy, and the type of policy (e.g., a workers' compensation policy, a general liability policy, or a customized policy). Information that may be collected or reviewed during the risk path interview 50 may include the identities of the insured's employees, officers or owners and their roles with the insured; how long the employees, officers or owners performed work during the term of the policy; and the compensation provided to the employees, officers and owners throughout the term. During a risk path interview, questions may also be asked about the nature of the insured's business operations. For example, if the insured 12 owns a restaurant, the insured 12 may be asked if it provides delivery. If the insured answers “yes,” the insurer 60 and its analysts will be instructed to look for drivers when it conducts its review. Similarly, the insured 12 may also be asked if its restaurant provides table service. If the insured answers “yes,” then the insurer 60 and its analysts will be instructed to look for employees who may be listed as waiters or servers. Either the account interview 44 or the risk path interview 50, or both, may include dynamic components.

After an account interview 44 and/or a risk path interview 50 has been completed, or at any time during the electronic PHR process, an insured 12 can also submit supporting documentation 52 through the electronic PHR system portal 30. Documents may be submitted in any manner, such as by uploading files through the portal 30, by tagging documents with a bar code prior to sending them via the fax machine 17, or by E-mailing or mailing documents that have been bar-coded or otherwise identified by the insured 12. Regardless of how the supporting documentation 52 is submitted, it may be combined or otherwise bundled 54 with the answers and other information provided by the insured 12 to allow a premium audit support team member 72 to easily review the results of the audit.

The insurer networked server 64 may also include integration systems for receiving the results of the interviews, sending audit interview information to the insurer 60, receiving and processing supporting documents, and/or for updating audit information. The audit data and supporting documentation may also be stored in the insurer database 62 for later retrieval and processing. The current status of the premium audit can also be stored in the insurer database 62, which may be accessed by the electronic PHR system portal 30, the insurer 60, the premium audit support team 72, the service center 70, and/or a third party 80. Additionally, the insurer 60 may also provide host systems for audit automation and/or for saving documents and/or images to one or more insurer databases 62.

Using the electronic PHR system portal 30, the insured 12 may monitor the status of its audit and review all of the information and supporting documents that were submitted with the audit, regardless of the source. Similarly, a member of the premium audit support team 72 may also review an entire audit pertaining to an insured 12, including supporting documents 52. Therefore, the portals may be used by either the insured 12 or the insurer 60 to confirm that the insured 12 has answered questions correctly and that the supporting documents 46 provided in connection with the audit are sufficient. Based on this information, a premium audit adjustment can be determined by the insurer 60.

A number of individuals associated with the insurer 60 having different levels of responsibility and access to information may be involved in the audit process, including, for example, a processor or reviewer, a team lead, a manager or assistant manager, and an administrator. Typically, a processor or reviewer may only be able to view or access work associated with his or her individual identification, or the team identification to which he or she is assigned. The processor or reviewer may not be able to view or access an office's entire work list, other offices' work lists, or the work lists of the organization as a whole. However, a processor or reviewer may have the capacity to “edit” work assigned to his or her individual identification, or the team identification, but not the capacity to “re-assign” work. For example, a processor or reviewer could be responsible for reviewing particular set of audit files individually, or a larger set of audit files as part of a team.

A team lead may typically be able to view or access work associated with his or her team identification, or with any individual identifications assigned to his or her team and, optionally, an office's entire work list. The team lead may not typically be able to view or access other offices' work lists, or those of the organization as a whole. The team lead may have the capacity to “edit” work assigned to his or her individual identification, the team identification and the office, as well as the ability to “re-assign” work within his or her team, but not to another team. For example, a team lead could manage multiple reviewers.

A manager or assistant manager may typically be able to view or access work associated with any team identification and/or any individual identifications assigned to his or her office, as well as an office's entire work list. A manager or assistant manager may also be able to view other offices' work lists and those of the organization as a whole. The manager or assistant manager may have the capacity to “edit” and to “re-assign” work assigned to his or her office, but will generally not be able to move/re-assign work from one office to another.

An administrator may typically be able to view or access work associated with any team identification and/or any individual identifications, as well as all office work lists and those of the entire organization. An administrator may typically be able to view or edit all offices' work lists and those of the organization as a whole, and may also have the ability to “re-assign” or “move” work from one office to another.

In accordance with one embodiment of the present invention, third party dynamic interview platforms may be used in connection with an electronic PHR system or process. Such platforms may be flexibly configured to ask questions of an insured in any desired order. In one embodiment of the invention, an insurer can send insured, policy, and/or configuration information to a third party-hosted interview platform. A third party platform may host the online dynamic interview process, guide the insured through a log-in process and/or registration, as well as a series of interview questions, and also provide instructions for delivering supporting documents to the third party or to the insurer. For example, the insurer can send an insured's insurance policy data to the third party platform for storage within its system. Such data may then be referenced when an insured accesses the system in order to complete an interview.

A third party platform may be linked to an insurer audit system, such that all the information collected from the interview is transferred back to the insurer. For example, such a transfer may be performed using a secure third party file transfer site. Once the information is received by the insurer, the information may be stored in the insurer database 62. Image information for supporting documents can be stored in the same database, or alternatively, in a database system specifically for storing image information. This information can then be linked with data in the insurer database 62.

In another embodiment of the present invention, a dynamic interview platform can be integrated with the insurer and with other components of the insurer audit system, thereby removing the need for a third party interview platform vendor and a third party transfer site for transferring configuration information. The integrated platform can access the same information as the audit platform.

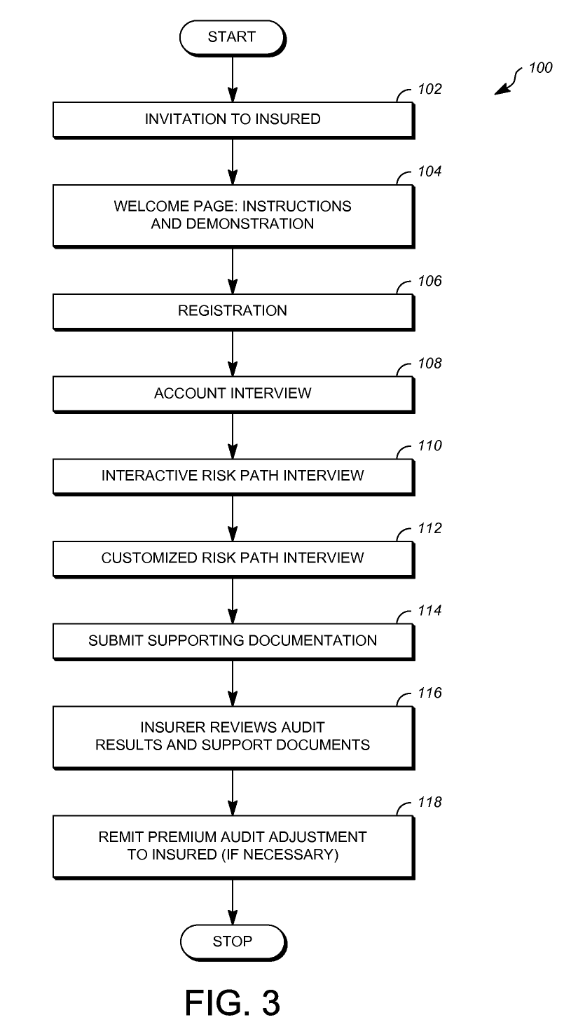

Referring to FIG. 3, an overview of one embodiment of an electronic PHR process 100 according to the present invention is shown. The process generally includes delivering an invitation to an insured, presenting a welcome page including instructions and/or a demonstration, as well as contact information for a service center; registration; a risk path dynamic interview; the submission of supporting documents; review by the insurer; and the remittance of a premium audit adjustment, if necessary. Those of skill in the art will recognize that where an audit system is shown as having one component in communication with other components, the functions of such components may be combined or integrated into a single system and executed on one or more servers.

In the illustrated embodiment, the audit process 100 begins at 102, with the delivery of an invitation to the insured. The invitation can be sent by any standard means, such as by mail, by facsimile or electronically (e.g., by E-mail). The invitation may contain instructions on how to begin the audit process. For example, the invitation can direct the customer to a website where an electronic PHR portal may be accessed. At 104, when the insured 12 visits the website, the insured may view a welcome page that may provide an overview of the process, as well as instructions and a demonstration that may instruct the insured as to how to properly complete an audit using the electronic PHR system. The welcome page may also provide the insured with contact information for a service center, in the event that the insured encounters any difficulties in working with the system.

Next, at 106, the insured 12 may register with the electronic PHR system prior to beginning the interview process. Registration permits an insured to create an account with a user name and a password, and to save its progress through the interview process, and to complete any steps at a later time. After the insured has registered, an account interview is conducted at 108 in order to obtain background account (e.g., demographic) information about the insured and its business, to identify alternate designees or representatives of the insured, and to confirm that an appropriate interview has been selected for the insured. After the account interview has been completed, at least one of an interactive dynamic risk path interview and a customized risk path interview, may be completed at 110 and 112.

During or after the completion of the interviews, the insured 12 can submit any information that may be required in support of their audit at 114. Once all required information has been submitted, the interview results may be bundled together and provided to the insurer 60, which may then review the results of the interview and the supporting documents at 116, in order to determine whether a premium audit adjustment is necessary. During the review of the audit information, the insured can be notified by E-mail of any changes. At 118, a premium audit adjustment may then be invoiced to the insured, if the results of the audit indicate that such an adjustment is necessary. The adjustment may require a payment by the insured 12 to the insurer 60 to cover unpaid premium (i.e., an “additional premium” adjustment) or a payment by the insurer 60 to the insured 12 to cover overpaid premium (i.e., a “return premium” adjustment). In some cases, no adjustment is necessary, resulting in a “calculated even” status.

When an insured is completing an audit interview, the electronic PHR system monitors the insured's progress, and maintains the records of the audit updated as to the status of the interview. Depending on the steps that have been taken by the insured, the electronic PHR system may also send reminders to the insured at various times, to remind the insured of any aspects of the audit that remain outstanding. Where a submission is incomplete, inconsistent, or unsupported by the documentation, the insured can be contacted to remedy any discrepancies.

Between an insured's receipt of an invitation to participate in the electronic PHR process and the final remittance of a premium audit adjustment to the insured, an audit may be considered to be in various stages of completion. Before an insured has registered, the audit may be considered “incomplete.” After the insured has completed the registration process, the audit may be considered in a “registered” stage, until the interviews have been completed. At that point, the audit may be considered to be in an “interview complete” stage, until the insured sends in any remaining supporting documentation.

An audit may be considered to be in an “under review” stage once all supporting documentation has been received. An insurer's representative will review the information, make additional contact with the insured and/or its representatives, if necessary, and validate the completeness of the data received. An audit may be considered to be in a “submitted” stage once the representative has validated the completeness of the data and transferred the data to the insurer database 62.

An audit may be considered to be in an “audit processed” stage once a rating has successfully completed, but will be considered to be in a “non-compliant” stage when the audit is marked uncooperative. An audit will be considered to be in an “estimated audit” stage when the an estimated audit requested has successfully rated. When an audit is in the “non-compliant” stage, an insured can contact the insurer to have the audit completed, and the audit will not be moved to a “compliant” stage until the insured has provided all the information necessary to complete the audit. The audit may be considered to be in a “disputed” stage when the insured has completed its audit on-line, but then disputes the results of the audit. Finally, an audit may be in a “revision” stage, such as when the audit is subject to bureau criticisms, experience modification changes, litigation, state mandates, system errors, processing errors, etc.

An insured may opt out of using the electronic PHR system to complete an audit at any time. The insured may then simply print any necessary forms from the electronic PHR portal and complete them in paper format. Depending on the stage of the audit at the time the insured elects to opt out, the printed forms may be pre-filled with the relevant information that the insured may have already entered during the electronic PHR process. For example, if an insured opts out of the electronic PHR process after conducting an account interview, the printed forms may be pre-filled with account information that was provided during the account interview. Any completed paper forms may be sent to the insurer, such as by fax, by mail or by any other means, and the submission may be reviewed by the insurer.

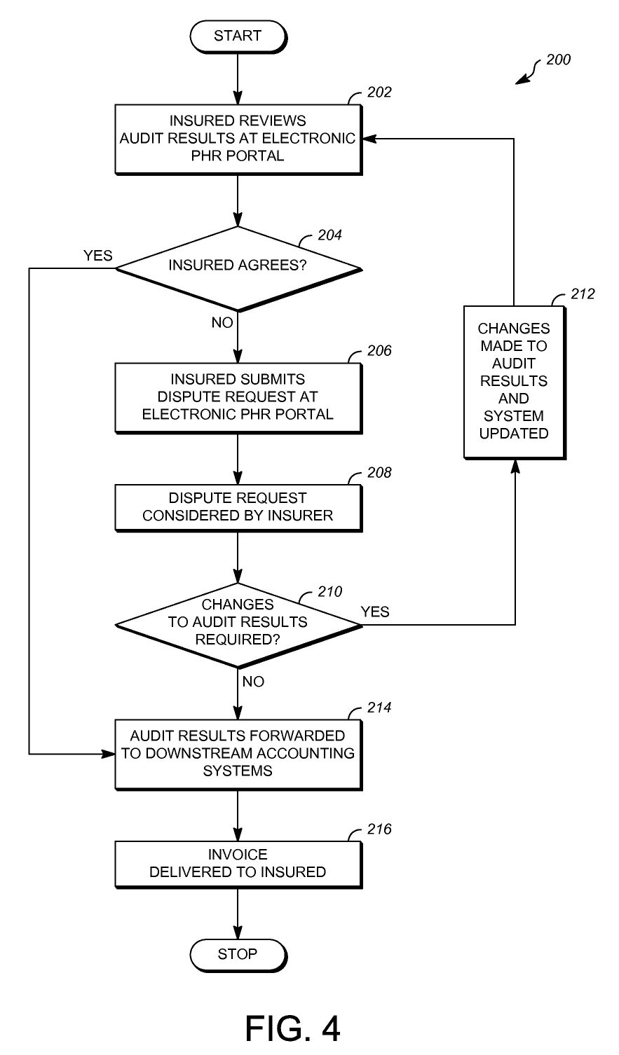

After an insured 12 has submitted an electronic PHR, and after the insurer 60 has completed its audit, the insured may elect to dispute the audit results, including the amount or degree of any premium adjustment. Referring to FIG. 4, an exemplary post-audit dispute path 200 according to one embodiment of an electronic PHR process is shown. At 202, an insured can view the results of a premium audit using an electronic PHR system portal 30, for example, and indicate whether it agrees with the audit results, including any premium adjustment. At 204, if the insured agrees with the premium audit results, then, at 214, the audit results are forwarded to downstream accounting systems, and at 216, an invoice is delivered to the insured. If the insured disagrees with the audit results, then, at 206, the insured may submit a dispute request using the electronic PHR system portal 30, for example. In some embodiments, an insured may use the electronic PHR system portal to provide data to be reviewed by the insurer, and may reopen an interview to modify or provide additional supporting documents through the portal. Any revised data submitted by the insured through the electronic PHR system portal may flow automatically to the insurer.

At 208, an insured's dispute request may be reviewed by the insurer, such as by an automated audit system and/or a dispute resolution team, which may receive an alert indicating that the insured disputes the results of the audit. If the insurer determines that the insured's dispute is meritorious, for example, if the insured information is not current or complete or the insured has not completed a dynamic interview or there is other information or factors that should be considered in the price calculation, changes to the audit results may be made at 212, the insurer's records may be updated, and an updated audit results document may be generated and delivered to the insured for its review. In some embodiments, the system may launch (or re-launch) a dynamic interview (or a portion thereof), in order to obtain the needed or appropriate data to re-calculate the premium.

If the insurer determines that no changes to the audit results are required, the insured may be notified of the insurer's decision and, at 214, the audit results may be forwarded to downstream accounting systems. At 216, the insured receives an invoice from the insurer for the premium adjustment, reflecting the original amount.

In some embodiments, the user or insured may use the electronic dispute resolution process 200 without using the dynamic audit process 100 described herein and shown in FIG. 3, for example, or may use the dispute resolution process 200 and then launch the dynamic audit process 100 shown in FIG. 3 to obtain an updated premium. For example, if the insured receives a premium increase from the insurer and the insured does not agree with the pricing, the insured may enter the dispute resolution portion of the portal to dispute the premium increase as described in FIG. 2. This may be available from a portal landing page (not shown) where the user can select to launch a dynamic audit, such as is shown in FIG. 3, or a dispute resolution process, such as is shown in FIG. 2. If the insurer concludes that changes to the audit results are required (at 210), for example, if the information is not current or complete or the insured has not completed a dynamic interview, the block 212 may bring the insured to a dynamic audit interview in order to obtain more information and provide an updated price, as discussed herein.

The electronic PHR system may consider a variety of factors when determining the risk path for a particular insured's business. Such factors may include the policy type, the insurance market, the service office as agent, the insured's governing class code, the relevant Standard Industry Classification (“SIC”) code, any premium basis, any package policy, or any other factors. The risk path is used to group businesses with similar risk characteristics together, and to determine the questions that the insured will be asked during an interview. In some embodiments of the present invention, the electronic PHR system logic will only derive one risk path per policy. In some other embodiments, one or more risk paths may be considered when reviewing the policy.

In general, a risk path interview conducted using an embodiment of the electronic PHR system begins by determining the type of policy that is held by the insured. For example, the insured may hold a workers' compensation policy, a general liability policy, or other policy, such as a customized policy, for example. Identifying the type of policy narrows the risk paths that may be relevant to the insured, and may also identify the first questions to be asked during an interview. For example, where an insured holds a general liability policy with the insurer, question sets may be directed to general matters regarding the policy itself (e.g., questions regarding the premium basis, market indicators, governing class codes, and/or SIC codes), as well as the insured's payroll, sales, and technology, and also the specific business type. The insured's responses to each of these questions will be used to determine the appropriate risk path for the insured. For example, if the policy is a general liability policy, the premium basis is sales, the market indicator is Other, and the SIC code is 58**, then the risk path is that of a restaurant, and only questions relevant to restaurants will generally be asked.

Where an insured holds a workers' compensation policy with the insurer, question sets may be directed to general matters regarding the policy itself (e.g., whether a service office is acting as the insurance agent, and whether the policy is agency billed), as well as the insured's payroll, owners, officers, employees, and volunteers, along with the specific business type. For example, questions may relate to a market indicator, a governing class code (such as agricultural services, domestic, construction/contractor, entertainment, restaurant, educational/religious, or automotive/gas station businesses) and/or SIC codes (such as transportation, construction/contractor, lodging, real estate/property management, personal services, professional services, medical/healthcare, and/or fire protection services).

Where an insured holds a customized policy with the insurer, question sets may be directed to common general liability, workers' compensation or other standard policy features, where necessary, and also the customized aspects of the policy. Additionally, risk paths may be determined based on predetermined criteria such as one or more of industry, location, type of insurance, type of risk, type of insurance policy, type of insured, partial or full SIC code, and the like.

Additionally, questions may also focus on the insured's type of business and its relevant risks. For example, where an insured's business is categorized as a restaurant, the electronic PHR system may ask if the insured offers delivery, and may assign one or more classification codes to the insured's business. Such classification codes may change slightly from year to year, depending on the scope of the insured's business, and are generally used to determine an insured's premium.

In some cases, the risk path cannot be determined based on the policy type alone, and the electronic PHR system can ask the appropriate questions so that the risk path can be determined. Alternatively, the insured can directly specify the risk path.

As is set forth above, the questions asked during the various interviews depend on the risk path associated with each insured and the type of policy held by each insured. According to embodiments of the invention, each risk path has a series of question sets that were developed specifically for businesses that obtain insurance coverage for a particular business need, and within each risk path, a set of generic questions is also asked. Information and data provided in a risk path interview may be stored in a grid, for example, that pertains to the relevant aspect of the business and presents the information and data in an easily reviewable format.

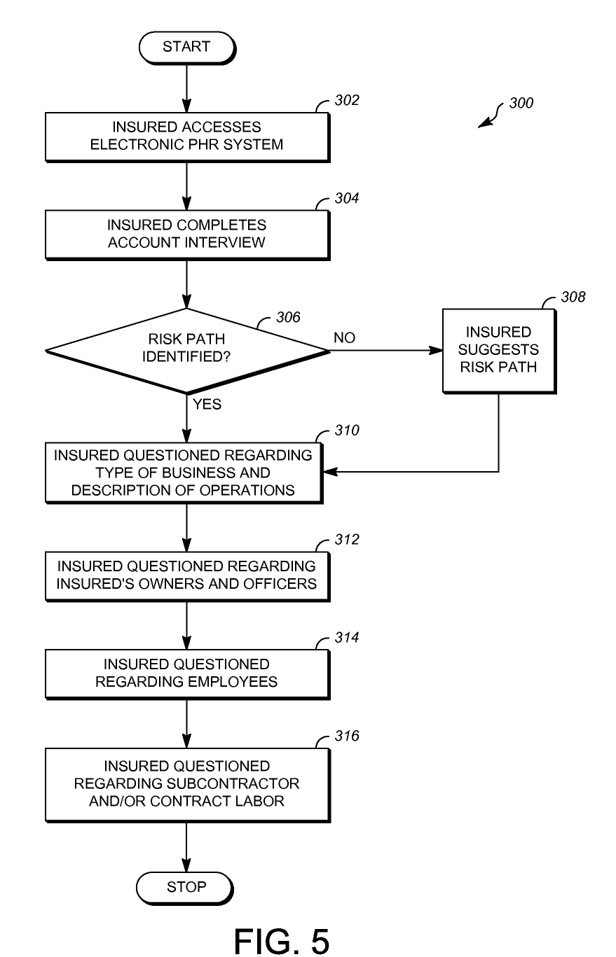

Referring to FIG. 5, an exemplary risk path interview process 300 for a workers' compensation policy is shown. At 302, the insured accesses the electronic PHR system and, at 304, completes an account interview. At 306, if the insured's risk path is known, i.e., based on data provided to the insurer, the insured may begin to participate in a risk path interview. If the insured's risk path is not known or if the insured disagrees with the provided risk path, then at 308, the insured may identify or suggest a risk path.

At 310, the insured may be asked generic questions, which may include questions regarding specific aspects of the business and its particular operations, and enable the risk path interview to be customized to the particular insured. At 312, the insured may be asked questions regarding its officers and/or owners. At 314, the insured may be asked questions regarding its employees. At 316, the insured may be asked questions regarding any subcontractor and/or contract labor, if necessary.

As the data is provided by the insured at 312, 314, and/or 316, the data may be assembled into one or more grids, i.e., an owner/officer grid, an employee grid, and a subcontractor and/or contract labor grid. Finally, during an interview, an insured may have the opportunity to update any incorrect information, such as its name, location, or contact information, or to “opt out” of the risk path interview, print out a paper copy of a PHR form, and complete the PHR forms on paper.

The scope of the risk path interview is generally determined by the relevant business and industry, as well as the type of policy held by the insured, and each individual type of business or industry generally has a unique risk path for each policy held with the insurer. For example, where the insured operates an entertainment business and holds a worker's compensation policy with the insurer, a risk path interview may include questions regarding the particular type of entertainment provided. For example, the insured may be asked to provide data or information including an updated description of operations and further details, including whether the business has live entertainment, theater, amusement park or water park operations, race tracks, miniature golf, arcades, carnivals or movies and television production. Additionally, the insured may be asked questions regarding its employees, including whether its employees receive tips, or if the insured uses subcontractor and/or contract labor, which may drive other question sets depending on the answer(s) provided by the insured.

Where the insured operates a catering service, a risk path interview may include questions regarding the services provided by the caterer and its employees, including the wait staff, valet or delivery services (if applicable), alcoholic beverage sales, and a detailed description of the operations, including whether employees are authorized to accept tips. A customized employee grid and sales grid may be assembled based on the answers provided by the insured.

Where the insured is a spiritual or religious entity, such as a church, a risk path interview may include questions regarding the services provided to parishioners or followers, and any employees or volunteers, as well as whether housing is provided. A customized employee and subcontractor and/or contract labor grid may be assembled based on the answers provided by the insured.

Where the insured operates a business relating to automobiles, a risk path interview may include questions regarding the nature of services provided by an insured. For example, the insured may be asked whether the business is a gas station, and, if so, whether the gas station is full service or self-service. Additionally, the insured may be asked whether the business provides automotive repairs, automotive leasing, car washes or auto parts sales, or whether the business also includes convenience stores.

Where the insured operates an agricultural business, a risk path interview may include questions regarding the nature of the business (e.g., whether it is a farm, a tree farm, a nursery, an orchard) and the number of employees. Additionally, the risk path interview may also include questions based on housing provided for farm workers, or unpaid relatives who may perform work for the business. A customized employee and subcontractor and/or contract labor grid may be assembled based on the answers provided by the insured.

Where the insured operates a temporary agency, a risk path interview may include questions regarding the type of work for which the agency may provide employees, including leased and/or temporary personnel, and a customized employee and subcontractor and/or contract labor grid may be assembled based on the answers provided by the insured.

Where the insured operates a real estate and/or property management company, a risk path interview may include questions based on employees and any housing that may be provided, as well as property management functions performed by the employees, any appraisals of the property under management, and also any associations with which the insured and/or the property is affiliated. A customized employee and subcontractor and/or contract labor grid may be assembled based on the answers provided by the insured.

Where the insured operates a transportation-related business, a risk path interview may include questions based on the type of business operation (e.g., taxi or livery service, towing company, tour bus provider, horse-drawn carriages, towing services, trucking and hauling, and delivery or courier service), as well as specific questions regarding the employees, including whether the business employs any contractors. A customized employee and subcontractor and/or contract labor grid may be assembled based on the answers provided by the insured.

Where the insured operates a membership organization, questions may be asked regarding employees, including paid staff and their respective wages and duties, and whether the organization utilizes volunteers. A customized employee and subcontractor and/or contract labor grid may be assembled based on the answers provided by the insured.

Where the insured operates a medical or health care organization, such as a hospital or clinic, questions may be asked regarding the type of care provided, the number and type of employees (e.g., doctors, nurses) and other related questions, such as security where the organization is located, ambulance access, and sales of any related devices (e.g., contact lenses, glasses). A customized employee and subcontractor and/or contract labor grid may be assembled based on the answers provided by the insured.

Where the insured operates a retail establishment, questions may be asked regarding the type and volume of goods sold, the location of the establishment and its hours of operation, and the number and type of employees. A customized employee and sales grid may be assembled based on the answers provided by the insured.

Where the insured operates a restaurant, questions may be asked regarding the type of food and beverages sold, including whether the restaurant sells alcoholic beverages. Additionally, questions may be asked about the type of seating available (e.g., dine-in, bar, lounge, tavern, take-out) and the hours of operation. Questions may also be asked regarding secondary features, such as whether the restaurant includes a dance floor, patio or valet parking Finally, questions may be asked regarding the employees, including whether they are permitted to receive tips, and the gross sales of the organization, as well as the number and locations of the insured's restaurant(s). A customized employee and sales grid may be assembled based on the answers provided by the insured.

Where the insured operates a lodging operation, such as a hotel, a motel, an inn, a bed & breakfast, or the like, questions may be asked regarding the number and type of rooms made available, any secondary facilities such as a banquet hall or restaurant, and the number and type of employees, including wait staff, valet parking, masseurs or masseuses, concierge services, and restaurants. General questions can also be asked to obtain employee wages and duties, as well as any subcontractor and/or contract labor. A customized employee grid, sales grid and subcontractor and/or contract labor grid may be assembled based on the answers provided by the insured.

Where the insured operates a professional service, such as a law firm or accounting firm, general questions can be asked, including wages and duties, the number and type of clients, and the like. A customized employee grid and sales grid may be assembled based on the answers provided by the insured.

Where the insured operates a fire protection service, such as a fire department, questions may be asked regarding the number and type of employees, such as firefighters (including salaried and volunteer fire fighters), including the wages, ranks and duties of each employee. A customized employee and subcontractor and/or contract labor grid may be assembled based on the answers provided by the insured.

Where the insured operates a construction company, questions may be asked regarding the type of operations (e.g., residential construction, commercial construction, excavation, plumbing), the number and type of employees and contractors hired, including trade descriptions, wages and duties, and material costs. A customized employee and subcontractor and/or contract labor grid may be assembled based on the answers provided by the insured.

The electronic PHR systems and methods of the present invention may include portals or browsers having graphical user interfaces having a variety of features that allow the insured to register to participate in an electronic PHR process; designate contacts and/or other delegates to act on behalf of the insured; view a demonstration; complete one or more interviews; submit additional documentation; opt out of the electronic PHR process; print or submit documents; request assistance from the insurer; and/or challenge audit results. For example, an interface may include boxes or other frames for entering text and other data, such as contact information; buttons for initiating actions and/or submitting information; arrows for advancing to a next page or returning to a previous page; boxes or “checkboxes” for selecting or de-selecting features; “pop-up” or other windows which may appear after moving a mouse, cursor or other like device over a portion of the interface; or any links or applications implemented using HTML, Java, and JavaScript, Java servlets, J2EE or any other standard language or protocol.

The electronic PHR systems of the present invention may also provide an internal portal, or an analyst worksheet portal, that may be used with the electronic PHR system, and may complement the electronic PHR portals that are accessed by the insureds. An analyst worksheet portal may be adapted to process both electronic PHR audits and non-electronic PHR audits. After an audit, such as an electronic PHR audit, is complete, audit details may be passed directly to the analyst worksheet tool, according to some embodiments of the invention.

When reviewing an electronic PHR audit, an analyst or reviewer may apply business rules in order to assign classifications to the insured. In some embodiments, the system may provide analysis tools to assist the analyst in reviewing the results of the electronic PHR audit, and may include automated logic to apply some predetermined business rules. For example, where a particular state places limits on the maximum and minimum chargeable wages for officers of a corporation, logic associated with the analyst worksheet may apply such wages to the insured, as well as rule effective dates versus policy effective dates. Additionally, there may be different limits on the maximum and minimum chargeable wages based on the insured's legal entity (e.g., a corporation may use an executive payroll limitation, while partnerships and sole proprietorships may use individual and partner payroll limitations, and limited liability companies may use executive, individual or partner payroll limitations, depending on state law). Furthermore, there may also be additional rules based on the type of policy (i.e., some states may have separate rules for workers' compensation versus general liability), and the rules may change on a periodic basis. Moreover, some states have at a flat charge for an individual or partner, while some states could set flat charges. In some embodiments, the formula for determining the chargeable wages for each owner or officer is as follows:

Employee Begin Date to Employee End Date = # of days employed
(includes begin and end date)
# of days employed / 7 = # of weeks employed (round up for any
remainder)
# of weeks employed X minimum** = Minimum charged
# of weeks employed X maximum** = Maximum charged
If the Net Wages > Maximum Charged, use the Maximum Charged
amount
If the Net Wages < Minimum Charged, use the Minimum Charged
amount
If the Net Wage is between the Minimum Charged and Maximum
charged, use the Net Wage

The calculation of the chargeable wage may not utilize the last day worked in the calculation (thus an annual policy cannot be considered more than 52 weeks). A partial week is considered a full week.

The analyst worksheet may also have automated alerts for predetermined business scenarios that may affect the audit. For example, the insured may have been a sole proprietor at the time the term of the insurance policy began, but may have incorporated during the term. Using a feed of information from an insured who is participating in an electronic PHR process, an analyst worksheet may automatically analyze the original entity type that was previously entered by the insured, compare the original entity type to the reported entity type at the beginning of the insurance policy term, and deliver an alert to the insurer if the original entity type and reported entity type are different. Alerts may also be delivered to the insurer, for example, if the address provided by the insured during an account interview is different from the original address that was previously entered by the insured.

Alerts may be issued for a variety of other reasons, including when a risk path that was derived based on information originally provided by the insured at the time that the policy was granted by the insurer differs from a risk path that was derived based on information obtained from the insured during an interview. For example, during a workers' compensation interview, the system may display an alert if the insured answers “yes” to questions regarding providing housing or supplementing the cost of housing for staff during the interview, and/or if the insured has a risk path of a domestic business but does not enter any domestic employees. Additionally, during a general liability interview, the system may display an alert if the insured answers “yes” to performing any installation, service, or repair work (e.g., sales or other risk path), if the insured indicates a location is closed or not active, if the insured indicates that it opened a new location, if the insured has a liquor liability-only policy and indicates during an interview that it does not sell liquor, and/or if the location of operations does not match the specified risk path. In addition, specified individuals (e.g., current assignee, manager, team lead, or administrator) may create, edit, or delete one or more free form alerts. In some embodiments, system derived alerts may be displayed before manually entered alerts.

According to one embodiment of the present invention, an analyst worksheet may incorporate one or more graphical user interfaces which may be utilized by an analyst to search for submitted PHRs or electronic PHRs, such as search boxes or fields, drop down menus, filters and any other features for performing searches. For example, an analyst may enter a PHR form type or number, policy number, effective date, name of an insured, name of an analyst, name of a processor, name of a pertinent service center or other identifier. Additionally, an analyst may search for a PHR or electronic PHR by the policy status, audit status or other aspect of the audit process. In such a manner, PHRs or electronic PHRs are not merely reviewed as printed documents or electronic documents (e.g., PDF files). Rather, the available information may been broken down into various sections that the analyst can easily interact with through the web-based application, and may find, input, and/or review PHR or electronic PHR data.

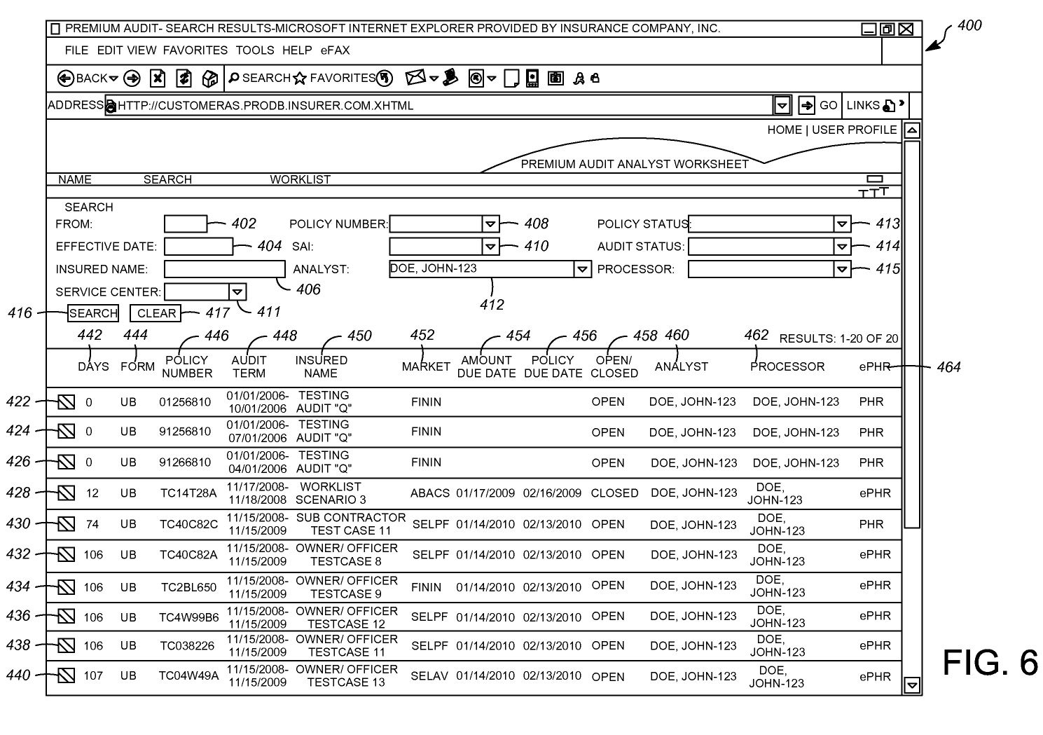

After an analyst has performed a search, results may be displayed in the analyst worksheet, in an interactive, sortable table format. Referring to FIG. 6, one embodiment of an analyst worksheet 400, displaying results of a search performed by an analyst in a table, is shown. As shown in FIG. 6, the analyst worksheet 400 includes search boxes for entering a form number 402, policy effective date 404, insured name 406, policy number 408 and SAI number 410. Additionally, the analyst worksheet 400 also includes drop-down menus for identifying the service center 411, analyst 412, policy status 413, audit status 414 and processor 415. The analyst worksheet 400 further includes a button 416 for initiating a search based on the content of the search boxes 402-410 and/or the selections at the drop-down menus 411-415, as well as a button 417 for clearing any such content from the search boxes 402-410 or selections from the drop-down menus 411-415.

The analyst worksheet 400 shown in FIG. 6 also includes a table 420 containing data pertaining to policies 422, 424, 426, 428, 430, 432, 434, 436, 438, 440. The table 420 displays data in sortable columns corresponding to the number of days 442 that audits of policies 422-440 have been pending, the forms 444, the policy numbers 446, the audit terms 448, the insured name 450, the pertinent market 452, the audit due date 454, the policy due date 456, the status 458 (e.g., open or closed) of the respective audit, the name of the analyst 460 to whom the audit has been assigned, the processor 462 of the audit, and an indicator 464 as to whether the PHR was submitted electronically or in paper form. From the table 420, an analyst can easily select a PHR or electronic PHR to review an overview screen containing more detailed information that can be used to verify correctness of the submission. The overview screen may display an insured's name, audit type, policy prefix form number, audit term, service center, due date, assigned analyst, market, whether the audit was previously a physical audit, whether any claims exist, whether the policy has an endorsement, the business type, and the determined risk path. Specifically regarding electronic PHR data, an overview screen may display the insured's selected risk path, whether the insured declined the interview, the legal entity, and the insured's selected legal entity. An analyst may also enter information about the operation of the insured to assist with this audit, or a future audit.

An analyst worksheet may be used to review any data and information regarding the insured's policy, as well as the responses provided to questions asked during interviews. For example, an analyst worksheet may display the title, name, state, from date, to date, gross wages, adjustments, net wages, chargeable wages, and classification of each of the officers or owners of an insured. The analyst worksheet may also include buttons or other features which would permit an analyst to save any changes; assign a classification to an owner/officer; perform a bulk include (using checkboxes); perform a bulk exclude (using checkboxes); delete, edit, include, exclude and/or create an owner/officer; or adjust and manage comments. For example, an officer or owner may be excluded based on an endorsement on the policy, inactive operations, no remuneration, status as a non-profit organization volunteer. Additionally, an officer or owner may be excluded if he or she is expressly not covered by the policy, or covered by another policy, or by state statutes, rules, or regulations.

The analyst worksheet may also permit an analyst to review employee data submitted with an electronic PHR, including summary information about classifications of the insured's workers, such as the state, split date, location, sublocation, class code, version, class code description, gross wages (sum of employees for each class code), overtime premium, double time premium, adjustment, and chargeable exposure. The analyst worksheet thus provides a way for an analyst to assign/unassign an existing classification to classes of employees. The analyst worksheet also may provide a way for an analyst to perform various functions including, but not limited to recording comments, entering a positive or negative adjustment amount, including or excluding each exposure (or multiple rows at the same time), and choosing a reason for including or excluding each exposure. In some embodiments, predetermined business rules may be automatically applied by the system. For example, as for officers, various business rules regarding chargeable wages may be automatically applied for employees. In some embodiments, the system will not subtract any overtime and/or double time amounts in chargeable wages calculations for employees in certain states (e.g., Pennsylvania, Delaware, or Nevada). The system may also automatically enforce a specified cap for chargeable wages in certain states (e.g., a cap of $36,000 for chargeable wages for employees in Nevada). Therefore, an analyst worksheet may permit an analyst to edit and/or add a domestic portion of electronic PHR data to provide information about domestic employees, including names, descriptions of work performed, beginning dates, gross wages, whether the employees worked more than a threshold number of hours (e.g., 20), whether room and board was included, and end date. Further, an analyst can add his or her own modifications, save or cancel changes, or add a new domestic employee.

The analyst worksheet may also permit an analyst to exclude contractors from consideration for a variety of reasons, including that a certificate of insurance was adequate, that the contractor is an independent contractor, or that the contractor is a service provider.

Additionally, the analyst worksheet may permit an analyst to perform exposure verification, including reviewing a total exposure and a verification deviation. For each time frame, it can display the description of that time frame, and the exposure. A sum of all exposures can also be displayed. The analyst worksheet may also permit an analyst to determine a chargeable amount, and may display, for each class code, the state, the split date, the location, the sublocation, the class code, the version, the class code description, the estimated exposure, the chargeable exposure, and the different between the estimate and chargeable exposure. Summary information may also be provided regarding the estimate exposure, chargeable exposure, and percentage difference (average). The analyst can review notes from the processor, and the tolerance documentation.

Finally, the analyst worksheet may also permit an analyst to save electronic PHR data and release the data for rating, thereby creating a simplified, fully electronic flow for conducting an electronic policy audit, and to send notifications, including that the electronic PHR was successfully released. The analyst worksheet may also permit an analyst to send notifications to the insurer, such as an underwriting staff, including that the electronic PHR data has incorrect legal entity type, incorrect federal employer identification number (“EIN”), incorrect address, state/location changes, classifications (added and not applicable), further information about exposure tolerances at the policy and class code level, and “other” (which can include further information from the analyst). In some embodiments, an analyst worksheet may apply business rules and create notifications (e.g., a PDF sent via electronic mail to other departments of the insurer, such as underwriting) automatically.

Embodiments of the present invention are directed to an electronic (e.g., web-based) PHR and premium determination system that may allow insureds (e.g., customers) and/or their designated representatives to complete a premium audit electronically, such as by entering information into one or more user interfaces. The user interfaces may be associated with a portal, such as a web-based portal, for example. Such a portal may allow an insured to complete a dynamic interview that may be customized for the insured according to one or more relevant risk paths and also to the insured's responses to questions asked during the interview. Embodiments of the present invention may also allow an insured to access its PHR on expiration of its policy.

Audits conducted using an electronic PHR system may include customized and dynamic interview paths. For example, when determining the risk that an insured's business represents, various questions may be asked. Depending on how the questions are answered, different questions may be asked of each insured. For example, an insured may be asked whether it has employees. If the insured answers “yes,” the insured will be asked various information about its employees. If the insured answers “no,” then the insured will not be asked about employees, and other questions will be asked throughout the remainder of the interview. In addition, to further accelerate the interview, answers may be pre-filled on behalf of the insured based on its responses to previous questions, information regarding a previous audit, information on file with the insurer, or a likelihood of a particular answer. Such features may permit an insured, in some cases, to simply click “continue” in order to proceed with the interview, without having to fill in various answers.

According to one embodiment of the present invention, audits conducted using an electronic PHR system may include customized or customer-focused risk paths. Where similarities exist among several business types, it may be useful to categorize similar businesses as a “risk type.” A set of questions associated with each risk type is referred to herein as a “risk path.” Thus, the risk path may be used to characterize the type of business owned and operated by the insured. The electronic PHR system, according to some embodiments, may identify different risk paths, and customize an interview according to one or more specific risk paths for each insured. Alternatively or in addition, an insured may be given the option of choosing a risk path that best describes its business. For example, a customized or customer-focused risk path may be used if the electronic PHR system otherwise failed to identify or classify the insured's business accurately. Correctly identifying one or more risk types for an insured's business may be important in the audit process for determining an insured's premium.

According to another embodiment of the present invention, an electronic PHR system permits an audit to be performed completely electronically. The system may capture data from the insured electronically during the interview, feed this data to audit systems, and apply automated edits, thus reducing the risk of human error during processing. The system can also electronically and seamlessly incorporate verification and other documents submitted by the insured during the audit process. For example, certain states may have different statutory limits for minimum and maximum compensation that may be relevant to the price of an insurance policy. When the state where an insured is located is identified, the system can automatically detect and enter the relevant maximum or minimum values so that a reviewer does not need to make that determination. As another example, the system can automatically detect and correct obvious mistakes, such as errors in the entry of dates or other information. The system can also identify any inconsistencies between entered data and an insured's data on file, or between different answers provided by the insured.

According to yet another embodiment of the present invention, an electronic PHR system can also be integrated with other processing systems to simplify the entire end-to-end processing of an audit. For example, the system can accept incoming data; systematically guide an audit staff through the key components of the PHR review process; automatically feed information to downstream billing and accounting systems; and produce a summary report for the insured to review, when the insured receives its voucher (i.e., proof of completion). Such a summary report may explain how state rules and limitations have been applied to the information provided by the insured during the interview, which may have been used to provide voucher results. Embodiments of the present invention may include an electronic analyst worksheet system and/or interface that may be used by audit staff to review an electronic PHR. Such a worksheet may be used to assimilate various information and simplify analysis.

Some embodiments of the present invention may allow an electronic PHR system to send alerts to members of an insurer's premium audit support staff, in order to advise the support staff of a situation that must be considered during a review. For example, such alerts may include a rush request for an audit, information from underwriting or customer service, or information obtained from an incoming call. The system can also send reminders to an insured after a certain period of time has elapsed with the audit in a particular stage of processing, thereby reminding the insured of an action that must be taken in order to complete the electronic audit process.

Some embodiments of the present invention may also provide assistance to an insured or to audit staff in completing the audit. For example, such assistance can include additional information and instructions to be used by an insured in completing the dynamic interview. The system can also display or present “help” features to assist the insured with the completion of the PHR. For example, by hovering a mouse over various questions, an insured can receive further information about particular information associated with a question.

Some embodiments of the present invention may further permit the submission of electronic documents (e.g., native files or scanned documents) through an electronic PHR system, including the automatic conversion of faxed documents to electronic documents having a TIFF or PDF format, for example, so that the entire process can be performed and recorded electronically. More specifically, insureds may attach or otherwise include electronic files such as payroll reports, accounting reports, and/or other related documents with their responses. Such forms may be bundled with the interview to form a complete file for review by an audit analyst. Submitting electronic documents and bundling files together may allow a complete electronic file to be transferred to an audit analyst's portal, and made accessible for further review and processing. Additionally, paper documents may be incorporated into an insured's file, such as through the use of bar-coded scan sheets or signature pages, which may be affixed to or accompany documents when they are delivered to the insurer, in order to make it easier for the insurer to identify and organize the documents.

According to one embodiment of the present invention, an electronic PHR system may include a customer portal (e.g., an external portal). An electronic PHR system customer portal can host a demonstration video that may be viewed by insureds prior to starting an interview. Additionally, the customer portal may also provide several HELP keys and instructions embedded into the customer portal for an insured to reference while actively completing an interview. The customer portal can be used by an insured to review the status of its audit submission. Once an insured registers with the system, the insured and/or its designated representative can return to their interview as often as necessary, and may subsequently submit supporting documentation as deemed necessary. Once the PHR materials have been submitted, the customer portal allows the insured to view a completed, bundled package in the form of an electronic file that includes the completed interview and submitted documentation. The insured can print the package or save the file to its local computer. The insured can also check the status of the audit process to determine if the process has advanced through pre-review, has been submitted for review, or has closed. Regarding post processing, the customer may have the ability to view a summarization of the audit review and an explanation of any adjustments that were applied to their audit based on state rules or officer inclusions/exclusions.

According to one embodiment of the present invention, an electronic PHR system may also include a customer service portal (e.g., an internal portal), for a service center customer service team to use when the team is contacted by an insured in need of real-time support. Using such a customer service portal, a customer service team may be able to review the interview as it is completed by the insured and provide assistance, clarification, and/or instruction to the insured regarding both the audit and electronic PHR process.

While capturing data electronically, an electronic PHR system may pass information along to an analyst worksheet once the information has been captured. In one embodiment, an analyst worksheet comprises a holding station where a service center team can (1) review information submitted by an insured or others; (2) validate the verification documents and support the data received from the insured; (3) apply business rules as dictated by governing bodies, such as state insurance bureaus; and/or (4) push final audit exposure numbers down to a respective issue system for flow-through (i.e., “no touch”) rating.

Some embodiments of the present invention may include features for automatically processing audits, and the information submitted by an insured or others. For example, an electronic PHR system according to the present invention has the ability to customize an interview, or to share collected data on specific risk types that will not require supplemental documentation to be submitted as part of the electronic PHR process. As a result, such audit results may pass to an analyst worksheet, where business rules (considering the state of the risk, type of business, type of classifications, etc.) may be automatically applied, and the audit may be pushed to an issue system for flow-through (i.e., “no touch”) rating, providing optimal timeliness in the most cost effective manner.

Some embodiments of the present invention may also allow an insured to opt out of the electronic interview process. Insureds can visit an electronic PHR system portal to begin an interview, but may later decide to print out the form and follow a paper-based PHR process, such as after completing the registration section of an interview. The electronic PHR system allows an insured to download and/or print out a risk path-based version of a PHR form if the insured opts out of completing an electronic interview, and submit the completed form to the insurer. Alternatively, in some cases where the insured opts out of the electronic interview process, it may download and/or print out a generic version of the PHR form.

According to one embodiment of the present invention, an electronic PHR system may also provide for dispute processing and alerting. An analyst worksheet, and/or an analyst, may apply a number of different business rules to the PHR during the audit process. At the conclusion of an audit, insureds and/or agents may wish to inquire as to how the audit was performed or, perhaps, to file a dispute concerning the results of the audit. Thus, in some embodiments, the electronic PHR system may provide a summary report and/or audit results document that ties the final product, i.e., a final audit voucher, with the responses submitted by the insured in its PHR, which may have been provided electronically or on paper. The summary report and/or audit results document will show the insured or agent, in plain English, what adjustments were made to the PHR in order to generate the final audit voucher. After an insured reviews the summary report and/or audit results document from an electronic PHR system customer portal, the insured will be able to submit a request to dispute the audit via the same electronic PHR system portal. Once the request is received, a dispute analyst may review the request and either adjust the audit or maintain the current audit results. Contact between the dispute analyst and the insured may be made via telephone, electronic mail, fax, and/or electronic PHR system portal in order to obtain the final disposition of the audit dispute results. Additionally, automated notifications may be provided regarding the progress of the dispute.

According to yet another embodiment of the present invention, an electronic PHR system may help to reduce the costs of processing PHRs, such as by reducing the costs of both processing PHRs and the personnel and supporting systems required to process paper PHRs, by potentially increasing revenue due to greater customer loyalty and the quality of service being provided, and by increasing the ease of doing business. Moreover, electronic PHR systems according to the present invention are expected to increase the accuracy of premium audits. Therefore, it may be expected that the costs associated with implementing an embodiment of the electronic PHR system according to the present invention may be recovered within a few years.

It is to be understood that the embodiments described above are not limited in application to the details of construction and to the arrangements of the components set forth in the above description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the invention be regarded as including equivalent constructions to those described herein insofar as they do not depart from the scope of the present invention, as defined by the claims.

In addition, features illustrated or described as part of one embodiment can be used in other embodiments to yield a still further embodiment. Additionally, certain features may be interchanged with similar devices or features not mentioned that perform the same or similar functions. It is therefore intended that such modifications and variations are included within the totality of the present invention.

The many features and advantages of the invention are apparent from the detailed specification, and thus, it is intended by the appended claims to cover all such features and advantages of the invention which fall within the scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

For example, the specific sequence of the processes described above may be altered so that certain processes are conducted in parallel or independent with other processes, to the extent that the processes are not dependent upon each other. Thus, the specific order of steps described herein, are not to be considered implying a specific sequence of steps to perform the processes described above. Other alterations or modifications of the above processes are also contemplated. For example, further insubstantial approximations of the above equations, processes and/or algorithms are also considered within the scope of the processes described herein.

What is claimed is:

1. A computer-implemented method of performing an electronic audit of an insurance policy comprising:
receiving a registration of an insured through an electronic audit system of an insurer, the electronic audit system comprising at least one processing device, wherein the insured holds an insurance policy with the insurer;
receiving a first plurality of responses through the electronic audit system, wherein each of the first plurality of responses is responsive to at least one of a plurality of account queries;
receiving a second plurality of responses through the electronic audit system, wherein each of the second plurality of responses is responsive to at least one of a plurality of risk path queries, and wherein at least one of the plurality of risk path queries is based on at least one of the second plurality of responses; and
determining, based on at least one of the first plurality of responses and the second plurality of responses, an adjustment to an insurance premium paid by the insured for the insurance policy.

2. The method of claim 1, further comprising receiving at least one supporting document through the electronic audit system.

3. The method of claim 2, wherein determining the adjustment is further based on the at least one supporting document.

4. The method of claim 2, wherein receiving at least one supporting document through the electronic audit system comprises:
receiving a bar code in association with the at least one supporting document, wherein the bar code is associated with the electronic audit; and
linking the at least one supporting document to the electronic audit.

5. The method of claim 2, further comprising providing audit results to the insured, wherein the audit results describe an application of at least one business rule to at least one of the first plurality of responses, the second plurality of responses, and the at least one supporting document, to determine the adjustment.

6. The method of claim 1, further comprising:
updating a first web portal with a current status of the electronic audit, wherein the first web portal is accessible to the insured; and
updating a second web portal with the current status of the electronic audit, wherein the second web portal is accessible to an insurer representative.

7. The method of claim 6, further comprising providing at least one analysis tool for assisting the insurer representative with reviewing the results of the electronic audit.

8. The method of claim 7, further comprising applying, using the processing device, at least one predetermined business rule associated with the analysis tool to assign a classification to the insured.

9. The method of claim 7, further comprising generating at least one alert responsive to at least one of the first plurality of responses, the second plurality of responses, and the at least one supporting document.

10. The method of claim 1, further comprising updating account information associated with the insurance policy based on at least one of the first plurality of responses.

11. The method of claim 1, wherein each of the plurality of risk path queries is associated with a risk path of the insured.

12. The method of claim 1, wherein the electronic audit system is a web-based application having at least one web portal.

13. The method of claim 1, further comprising transmitting a message to the insured, wherein the message contains an invitation to complete the electronic audit using the electronic audit system.

14. The method of claim 1, wherein at least one of the second plurality of responses includes an identification of a type of business operations of the insured.

15. The method claim 1, further comprising reviewing the adjustment to the insurance premium using the electronic audit system.

16. The method of claim 1, further comprising:
determining at least one rate classification code based on the second plurality of responses; and
determining the adjustment based on the at least one rate classification code.

17. The method of claim 5, comprising:
receiving a request for a review of the adjustment from the insured through the electronic audit system;
receiving information pertaining to the audit through the electronic audit system, wherein receiving information comprises at least one of:
performing a dynamic interview with the insured through the electronic audit system, wherein at least one query of the dynamic interview pertains to at least one of an account and a risk path of the insured; and
receiving at least one additional supporting document through the electronic audit system; and
revising the adjustment based on the information pertaining to the audit.

18. The method of claim 17, further comprising providing updated audit results to the insured describing the application of at least one business rule to the information pertaining to the audit to determine the revised adjustment.

19. The method of claim 17, further comprising transmitting at least one automated notification regarding a status of the review.

20. An electronic audit system, comprising:
a computerized processing device; and
a memory device in communication with the computerized processing device and storing specially-programmed instructions that when executed by the computerized processing device result in:
receiving by an insurer from an insured a registration, wherein the insured holds an insurance policy with the insurer;
receiving a first plurality of responses, wherein each of the first plurality of responses is responsive to at least one of a plurality of account queries;
receiving a second plurality of responses, wherein each of the second plurality of responses is responsive to at least one of a plurality of risk path queries, and wherein at least one of the plurality of risk path queries is based on at least one of the second plurality of responses; and
determining, based on at least one of the first plurality of responses and the second plurality of responses, an adjustment to an insurance premium paid by the insured for the insurance policy.

21. The device of claim 20, wherein the specially-programmed instructions, when executed by the computerized processing device, further result in:
receiving at least one supporting document.

22. The device of claim 21, wherein determining the adjustment is further based on the at least one supporting document.

23. A computer-readable memory storing instructions that when executed by a computer comprising at least one processor result in:
receiving, by a specially programmed computer device and from an insured, a registration of the insured, wherein the insured holds an insurance policy with an insurer;
receiving, by the specially programmed computer device, a first plurality of responses, wherein each of the first plurality of responses is responsive to at least one of a plurality of account queries;
receiving, by the specially programmed computer device, a second plurality of responses, wherein each of the second plurality of responses is responsive to at least one of a plurality of risk path queries, and wherein at least one of the plurality of risk path queries is based on at least one of the second plurality of responses; and
determining, by the specially programmed computer device and based on at least one of the first plurality of responses and the second plurality of responses, an adjustment to an insurance premium paid by the insured for the insurance policy.

24. The computer-readable memory of claim 23, wherein the instructions, when executed by a computer comprising at least one processor, further result in:
receiving at least one supporting document.

25. The computer-readable memory of claim 24, wherein determining the adjustment is further based on the at least one supporting document.

26. A computer-implemented method of performing an electronic dispute resolution of an insurance policy audit comprising:
providing to an insured through an electronic audit system of an insurer, the electronic audit system comprising at least one processing device, an adjustment to an insurance premium paid by the insured for an insurance policy held with the insurer;
receiving a request for a review of the adjustment from the insured through the electronic audit system;
receiving a plurality of responses through the electronic audit system, wherein each of the plurality of responses is responsive to at least one of a plurality of risk path queries, and wherein at least one of the plurality of risk path queries is based on at least one of the plurality of responses; and
determining, based on at least one of the plurality of responses, a modified adjustment to the insurance premium.

27. The method of claim 26, further comprising receiving at least one supporting document through the electronic audit system.

28. The method of claim 27, wherein determining the modified adjustment is further based on the at least one supporting document.
